(19) United States
(12) Patent Application Publication
(10) Pub. No.: US 2015/0116895 A1
(43) Pub. Date: Apr. 30, 2015

(54) CONDUCTIVE PASTE COMPOSITION FOR EXTERNAL ELECTRODE, MULTILAYER CERAMIC ELECTRONIC COMPONENT USING THE SAME, AND MANUFACTURING METHOD THEREOF

(71) Applicant: SAMSUNG ELECTRO-MECHANICS CO., LTD., Suwon (KR)

(72) Inventors: Seung Hee YOO, Suwon (KR); Sim Chung KANG, Suwon (KR); Byung Jun JEON, Suwon (KR); Jun Hyeong KIM, Suwon (KR); Eun Joo CHOI, Suwon (KR); Kyu Ha LEE, Suwon (KR)

(73) Assignee: SAMSUNG ELECTRO-MECHANICS CO., LTD., Suwon (KR)

(21) Appl. No.: 14/161,495

(22) Filed: Jan. 22, 2014

(30) Foreign Application Priority Data
Oct. 30, 2013 (KR) 10-2013-0130174

(51) Int. Cl. H01G 4/008; H01G 4/30; H01G 4/12; H01B 1/02

(52) U.S. Cl. CPC H01G 4/008; H01B 1/026; H01G 4/30; H01G 4/1227
USPC 361/301.4; 156/89.18; 75/252

(57) ABSTRACT

There are provided a conductive paste composition for an external electrode, a multilayer ceramic electronic component using the same, and a manufacturing method thereof, and more specifically, a conductive paste composition for an external electrode, allowing for decreased blister and glass beading defects by improving a removal of residual carbon at low temperature before necking between metal particles is generated and the metal particles are densified during a firing process of the external electrode, a multilayer ceramic electronic component using the same, and a manufacturing method thereof.

### CROSS-REFERENCE TO RELATED APPLICATION

This application claims the benefit of Korean Patent Application No. 10-2013-0130174 filed on Oct. 30, 2013, with the Korean Intellectual Property Office, the disclosure of which is incorporated herein by reference.

### BACKGROUND

The present disclosure relates to a conductive paste composition for an external electrode, a multilayer ceramic electronic component using the same, and a manufacturing method thereof, and more specifically, to a conductive paste composition for an external electrode allowing for decreased blister and glass beading defects, a multilayer ceramic electronic component using the same, and a manufacturing method thereof.

In accordance with the recent trend toward miniaturization of electronic products, demand for a multilayer ceramic electronic component having a small size and high capacitance has increased.

A multilayer ceramic electronic component has an increased number of stacked layers by reducing a thickness in order to achieve ultra high capacitance and thus, external electrodes have also been thinned. However, due to side effects caused by thinness of the external electrode, reliability may be deteriorated due to the infiltration of a plating solution at the time of performing a plating process.

In order to improve the deterioration in reliability due to the infiltration of a plating solution, the external electrodes should be densified so as to prevent the infiltration of the plating solution. In order to form the densified external electrodes, methods such as a method of using a fine metal powder, a method of using a fine glass powder, a method of improving an electrode firing temperature, and the like, are present.

In the case of a paste for a thin external electrode, fine metal particles and fine glass particles are used to provide excellent contactability and densification; however, a sintering initiation temperature and a sintering termination temperature may be low to cause a blister.

When metal particles are densified at a time at which a debinding process is uncompleted, a route through which gas generated by residual carbon at high temperature is discharged to the outside does not exist, thereby generating a blister.

In addition, in the case in which the debinding process is not smoothly performed during an electrode firing process of the paste for the external electrode, an electrode firing atmosphere is changed into a reducing atmosphere due to the residual carbon generated at high temperature. In this case, an oxide film thinly formed on a surface of the metal particle is removed while the residual carbon is changed into CO gas, or CO₂ gas at high temperature. However, due to the removal of the oxide film, the metal particle may be rapidly sintered in a local region and in the case, a glass beading defect may occur.

The following Patent Document 1 discloses a conductive paste for an external electrode including a copper powder and a second powder having a lower diffusion rate and a higher melting point than those of the copper powder; however, there is a limitation in effectively removing carbon at low temperature.

### RELATED ART DOCUMENT

(Patent Document 1) Korean Patent Laid-Open Publication No. 2011-0067509

### SUMMARY

An aspect of the present disclosure may provide a conductive paste composition for an external electrode allowing for decreased blister and glass beading defects by improving a removal of residual carbon at low temperature before necking between metal particles is generated and the metal particles are densified during a firing process of the external electrode, a multilayer ceramic electronic component using the same, and a manufacturing method thereof.

According to an aspect of the present disclosure, a conductive paste composition for an external electrode may include a copper powder; and a copper oxide powder.

The copper oxide powder may include at least one selected from a group consisting of CuO and Cu₂O.

The copper oxide powder may include a surface copper oxide powder having an oxide layer formed on a surface thereof.

The copper oxide powder may be included in an amount of 5 parts by weight to 42 parts by weight based on 100 parts by weight of the copper powder.

The copper oxide powder may have an oxide content of 15000 ppm or more.

The copper oxide powder may have an average particle size of 0.3 μm to 10 μm.

A removing rate of residual carbon may be 99.5% or more during a firing process of the conductive paste composition for an external electrode at 600° C.

According to another aspect of the present disclosure, a multilayer ceramic electronic component may include: a ceramic body including a plurality of dielectric layers; first and second internal electrodes formed in the ceramic body with the dielectric layers interposed therebetween to be alternately exposed to end surfaces of the ceramic body; and first and second external electrodes formed on outer surfaces of the ceramic body to be electrically connected to the first and second internal electrodes, respectively, wherein the first and second external electrodes include copper and copper oxide.

The copper oxide may be at least one selected from a group consisting of CuO, Cu₂O, and a surface copper oxide having an oxide layer formed on a surface thereof.

The copper oxide may be included in an amount of 5 parts by weight to 42 parts by weight based on 100 parts by weight of the copper.

The first external electrode and the second external electrode may have an oxygen content of 5000 to 15000 ppm, respectively.

According to another aspect of the present disclosure, a manufacturing method of a multilayer ceramic electronic component may include: preparing a plurality of ceramic sheets; forming internal electrode patterns on the ceramic sheets; stacking the ceramic sheets having the internal electrode patterns formed thereon to form a ceramic body; forming an external electrode pattern on at least one surface of the ceramic body using a conductive paste composition for an external electrode including a copper powder and a copper oxide powder; and firing the external electrode pattern to form an external electrode.

The copper oxide powder may be at least one selected from a group consisting of CuO, Cu₂O, and a surface copper oxide having an oxide layer formed on a surface thereof.

The copper oxide powder may be included in an amount of 5 parts by weight to 42 parts by weight based on 100 parts by weight of the copper powder.

The copper oxide powder may have an oxygen content of 15000 ppm or more.

A removing rate of residual carbon may be 99.5% or more during the firing of the external electrode pattern at 600° C.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a photograph showing a surface copper oxide powder contained in a conductive paste composition for an external electrode according to an exemplary embodiment of the present disclosure using scanning electron microscope (SEM);

FIG. 2 is a graph showing results of residual carbon contents after performing a heat-treatment depending on an oxygen content of the copper oxide powder;

FIG. 3 is a perspective view schematically showing a multilayer ceramic electronic component according to an exemplary embodiment of the present disclosure;

FIG. 4 is a cross-sectional view of line A-A′ of FIG. 3;

FIG. 5 is a process diagram showing a manufacturing method of a multilayer ceramic electronic component according to an exemplary embodiment of the present disclosure;

FIG. 6 is a graph showing results obtained by measuring residual carbon contents after performing a heat-treatment on respective conductive paste sheets for an external electrode according to Inventive Examples 1 to 3 and Comparative Example 1; and

FIG. 7 is a photograph obtained by performing a heat-treatment on respective conductive paste sheets for external electrode according to Inventive Examples 1 to 3 and Comparative Example 1 and observing microstructures of surfaces thereof using a scanning electron microscope (SEM).

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

A conductive paste composition for an external electrode according to an exemplary embodiment of the present disclosure may include a copper powder and a copper oxide powder.

The conductive paste composition for an external electrode according to an exemplary embodiment of the present disclosure may include a copper powder and a copper oxide powder, such that carbon contained in an organic binder, and the like, included in the conductive paste for an external electrode may be sufficiently removed in the form of CO gas or CO₂ gas at a temperature of 600° C. or less before necking between copper particles occurs and the copper particles are densified. That is, the residual carbon may be removed before the copper particles are densified, such that blister and glass beading defects may be decreased.

The copper oxide powder may include CuO, Cu₂O, a surface copper oxide powder having an oxide layer formed on a surface thereof, and the like, or may include a mixture thereof.

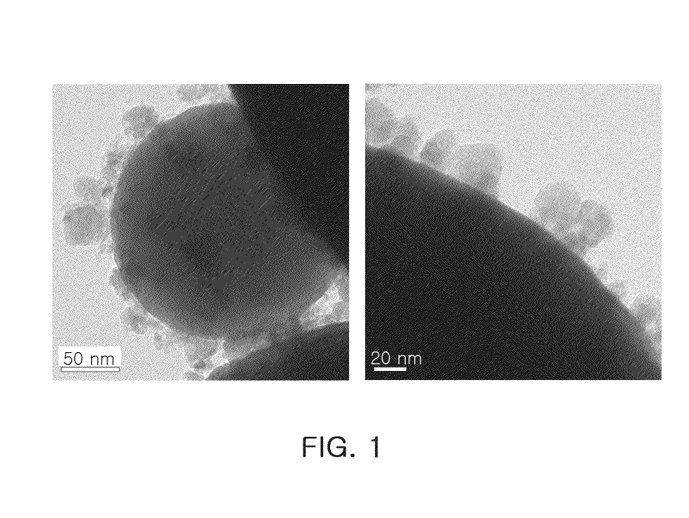

The surface copper oxide powder having an oxide layer formed on a surface thereof (see FIG. 1) may be formed by heat-treating the copper powder under an oxygen atmosphere.

The copper oxide powder may have an oxygen content of 15000 ppm or more.

In the case in which the oxygen content of the copper oxide powder is smaller than 15000 ppm, a removing rate of residual carbon of residual carbon at a temperature of 600° C. or less may be remarkably decreased.

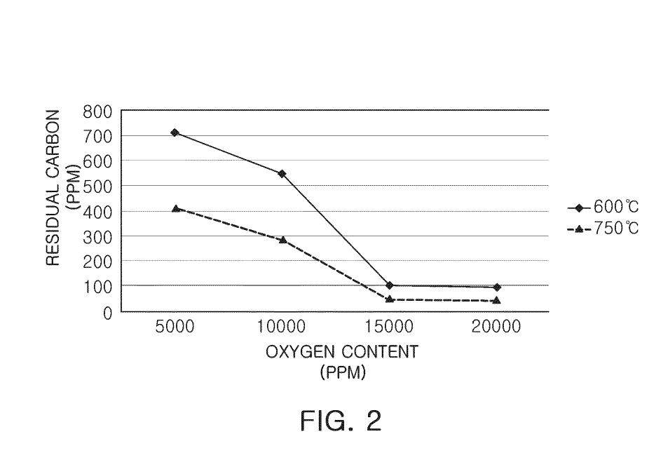

FIG. 2 is a graph showing the content of residual carbon after performing a heat-treatment depending on the oxygen content of the copper oxide powder.

Referring to FIG. 2, it may be appreciated that in the case in which the oxygen content of the copper oxide powder is 15000 ppm or more, the residual carbon content may be remarkably decreased, and in particular, the residual carbon content at 600° C. may be low, about 100 ppm.

The copper oxide powder may have an average particle size of 0.3 μm to 10 μm.

In the case in which an average particle size of the copper oxide powder is smaller than 0.3 μm, aggregation between copper particles and defects in contactability thereof may occur at the time of preparing copper oxide, and in the case in which an average particle size of the copper oxide powder is greater than 10 μm, thin and densified external electrodes may not be achieved.

The copper oxide powder is not specifically limited in view of a shape, but for example, may have a spherical shape or a flake shape.

The copper oxide powder included in the conductive paste composition for an external electrode according to an exemplary embodiment of the present disclosure may have a content of 5 parts by weight to 42 parts by weight based on 100 parts by weight of the copper powder.

In the case in which the content of the copper oxide powder is smaller than 5 parts by weight, residual carbon may not be sufficiently removed at low temperature before the necking between copper particles is generated and the copper particles are densified, and in the case in which the content of the copper oxide powder is greater than 42 parts by weight, defects in contactability with the internal electrodes may occur, and a degree of densification may be deteriorated due to a decrease in sintering driving force of the copper oxide powder.

In the conductive paste composition for an external electrode according to an exemplary embodiment of the present disclosure, a removing rate of residual carbon may satisfy 99.5% or more at the time of performing a firing process at 600° C. That is, the residual carbon may be removed by an amount of 99.5% or more at 600° C. before the copper particles are densified, such that blister and glass beading defects may be decreased.

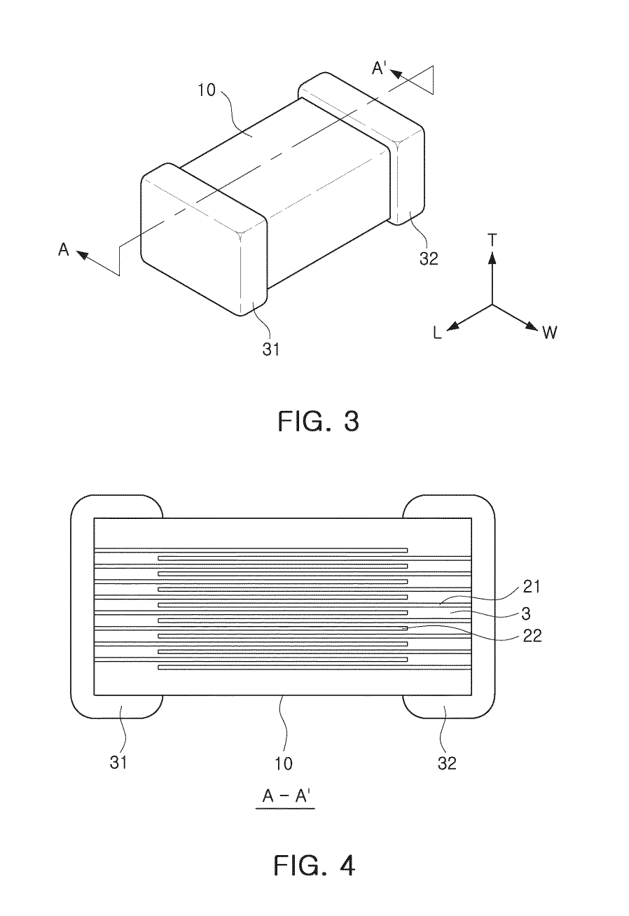

FIG. 3 is a perspective view schematically showing a multilayer ceramic electronic component according to an exemplary embodiment of the present disclosure, and FIG. 4 is a cross-sectional view taken along line A-A′ of FIG. 3.

Referring to FIGS. 3 and 4, the multilayer ceramic electronic component according to the exemplary embodiment of the present disclosure may include a ceramic body 10 including a plurality of dielectric layers 3; first and second internal electrodes 21 and 22 formed in the ceramic body 10 with the dielectric layers 3 interposed therebetween to be alternately exposed to end surfaces of the ceramic body 10; and a first external electrode 31 electrically connected to the first internal electrodes 21 and a second external electrode 32 electrically connected to the second internal electrodes 22, wherein the first and second external electrodes 31 and 32 include copper and copper oxide.

A raw material forming the dielectric layer 3 is not particularly limited as long as sufficient capacitance may be obtained, but may be, for example, a barium titanate (BaTiO₃) powder.

In the material forming the dielectric layer 3, various ceramic additives, organic solvents, plasticizers, binders, dispersing agents, and the like, may be added to a powder such as a barium titanate (BaTiO₃) powder, or the like, depending on an object of the present disclosure.

A material forming the first and second internal electrodes 21 and 22 is not particularly limited, but may be formed by using a conductive paste formed of at least one material selected from among silver (Ag), lead (Pb), platinum (Pt), nickel (Ni), and copper (Cu), for example.

Copper oxide included in the first and second external electrodes 31 and 32 may be CuO, Cu₂O, a surface copper oxide having an oxide layer formed on a surface thereof, or the like, or a mixture thereof.

The copper oxide included in the first and second external electrodes 31 and 32 may be included in an amount of 5 parts by weight to 42 parts by weight based on 100 parts by weight of the copper powder.

The first and second external electrodes 31 and 32 may be formed by applying the conductive paste for an external electrode according to the exemplary embodiment of the present disclosure, and performing a firing process at 650° C. to 900° C. The first and second external electrodes 31 and 32 formed as described above may have an oxygen content of 5000 to 15000 ppm, respectively.

Characteristics of the conductive paste for an external electrode are overlapped with those of the foregoing embodiment and accordingly, will be omitted in order to avoid a redundant description.

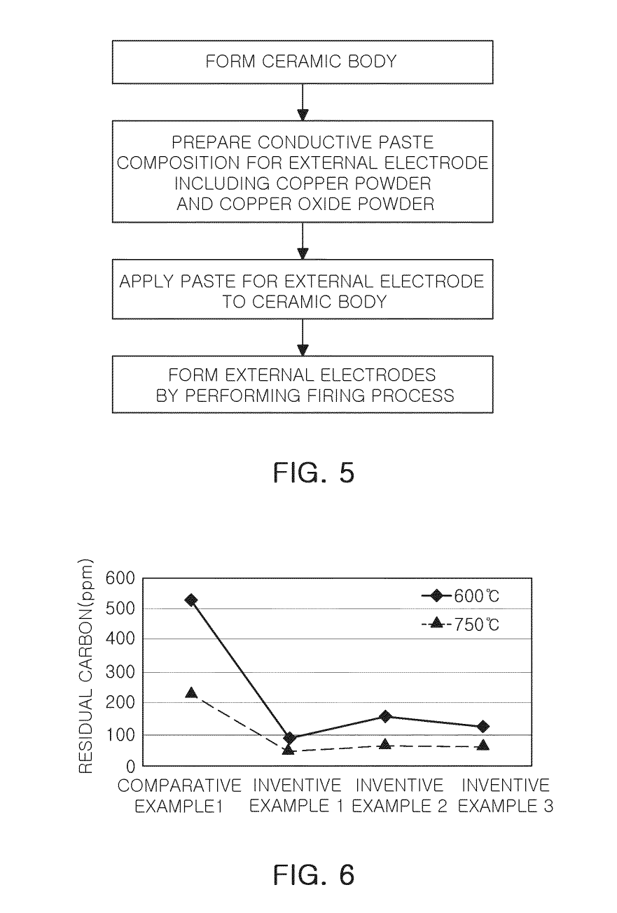

FIG. 5 is a process diagram showing a manufacturing method of a multilayer ceramic electronic component according to an exemplary embodiment of the present disclosure.

Referring to FIG. 5, a manufacturing method of a multilayer ceramic electronic component according to an exemplary embodiment of the present disclosure may include: forming internal electrode patterns on a plurality of ceramic sheets; stacking the ceramic sheets to form a ceramic body 10 including the first and second internal electrodes 21 and 22; preparing a conductive paste for an external electrode including a copper powder and a copper oxide powder; applying the paste for the external electrode on at least one surface of the ceramic body 10 to be electrically connected to the first and second internal electrodes 21 and 22; and performing a firing process to form the first and second external electrodes 31 and 32.

The ceramic sheets may be formed to have a thickness of several μm by applying a slurry formed by mixing a powder such as a barium titanate (BaTiO₃) powder or the like, with a ceramic additive, an organic solvent, a plasticizer, a binder, a dispersing agent, or the like, using a basket mill, to carrier films and drying the films.

Internal electrode layers may be formed by dispensing the conductive paste on the ceramic sheet and moving a squeegee in one direction thereof.

Here, the conductive paste may be formed of one of noble metal materials such as silver (Ag), lead (Pb), platinum (Pt), and the like, nickel (Ni), and copper (Cu) or a mixture of at least two materials thereof.

After the internal electrode layers are formed as described above, a laminate may be formed by separating the ceramic sheets from the carrier films and then stacking the plurality of green sheets on one another, in an overlapping manner.

Then, a ceramic body may be manufactured by compressing the ceramic sheet laminate under conditions of high temperature and high pressure and then cutting the compressed ceramic sheet laminate into a predetermined size through a cutting process.

Next, a conductive paste for an external electrode including a copper powder and a copper oxide powder may be prepared.

The copper oxide powder may include CuO, Cu₂O, a surface copper oxide powder having an oxide layer formed on a surface thereof, and the like, or may include a mixture thereof.

The copper oxide powder may have an oxygen content of 15000 ppm or more.

In the case in which the oxygen content of the copper oxide powder is smaller than 15000 ppm, a removing rate of residual carbon at a temperature of 600° C. or less may be remarkably decreased.

The copper oxide powder may have an average particle size of 0.3 μm to 10 μm.

In the case in which an average particle size of the copper oxide powder is smaller than 0.3 μm, aggregation between copper particles and defects in contactability may occur at the time of preparing copper oxide, and in the case in which an average particle size of the copper oxide powder is greater than 10 μm, thin and densified external electrodes may not be achieved.

The copper oxide powder is not specifically limited in view of a shape, but for example, may have a spherical shape or a flake shape.

The copper oxide powder included in the conductive paste composition for an external electrode may be included in an amount of 5 parts by weight to 42 parts by weight based on 100 parts by weight of the copper powder.

In the case in which the content of the copper oxide powder is smaller than 5 parts by weight, residual carbon may not be sufficiently removed at low temperature before the necking between copper particles is generated and the copper particles are densified, and in the case in which the content of the copper oxide powder is greater than 42 parts by weight, defects in contactability with the internal electrodes may occur, and a degree of densification may be deteriorated due to a decrease in sintering driving force of the copper oxide powder.

Next, the conductive paste for the external electrode may be applied to the ceramic body 10 to be electrically connected to the first and second internal electrodes 21 and 22.

Lastly, first and second external electrodes 31 and 32 may be formed by performing a firing process at 650° C. to 900° C.

Here, the first and second external electrodes 31 and 32 having decreased blister and glass beading defects may be formed by using the conductive paste for the external electrode including the copper oxide powder according to the exemplary embodiment of the present disclosure so as to sufficiently remove residual carbon by an amount of 99.5% or more at low temperature before copper particles are densified.

Hereinafter, although the present disclosure will be described in detail through the following Inventive Examples and Comparative Example 1, the description thereof should not be construed as being limited to the scope of the present disclosure, but is to help a specific understanding of the present disclosure.

### Inventive Example 1

A copper powder having an average particle size of 0.5 μm and a surface copper oxide powder in an amount of 12 parts by weight based on 100 parts by weight of the copper powder were mixed, and a glass particle having an average particle size of 0.5 μm, an organic binder, a dispersant, and an organic solvent were added to the mixture to be mixed and dispersed therein, such that a conductive paste sheet for an external electrode was manufactured.

### Inventive Example 2

A conductive paste sheet for an external electrode of Inventive Example 2 was manufactured by the same method as that of Inventive Example 1 except for the using of a CuO powder in an amount of 12 parts by weight instead of using the surface copper oxide powder of Inventive Example 1.

### Inventive Example 3

A conductive paste sheet for an external electrode of Inventive Example 3 was manufactured by the same method as that of Inventive Example 1 except for the using of a Cu₂O powder in an amount of 12 parts by weight instead of using the surface copper oxide powder of Inventive Example 1.

### Comparative Example 1

A conductive paste sheet for an external electrode of Comparative Example 1 was manufactured by the same method as that of Inventive Example 1 except for the fact that the surface copper oxide powder was not mixed therein.

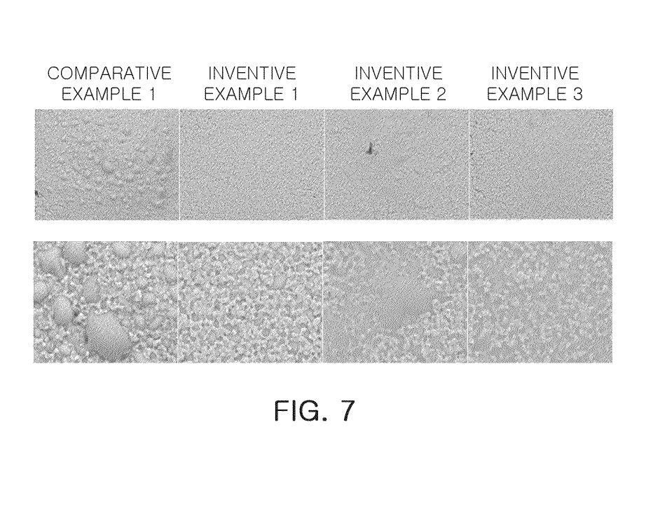

FIG. 6 is a graph showing results obtained by measuring the contents of residual carbon after performing a heat-treatment on respective conductive paste sheets for an external electrode according to Inventive Examples 1 to 3 and Comparative Example 1.

Referring to FIG. 6, in Inventive Examples 1 to 3 corresponding to conductive paste sheets for the external electrode including surface copper oxide, CuO, and Cu₂O, respectively, residual carbon may be remarkably removed, and in particular, residual carbon may be effectively removed even at low temperature of 600° C., as compared to Comparative Example 1 corresponding to conductive paste sheet for the external electrode not including a copper oxide powder. In addition, Inventive Example 1 using surface copper oxide showed an excellent effect as compared to Inventive Examples 2 and 3 including CuO and Cu₂O.

In Comparative Example 1, residual carbon was rapidly removed at a temperature between 600° C. and 750° C., such that at the time of firing electrodes, blister defects generated at a rate of about 18%; however, in Inventive Examples 1 to 3, the blister defect was not generated.

FIG. 7 is a photograph obtained by performing a heat-treatment on respective conductive paste sheets for external electrode according to Inventive Examples 1 to 3 and Comparative Example 1 and observing microstructures of surfaces thereof using a scanning electron microscope (SEM).

It could be appreciated from FIG. 7 that glass beading defect was generated in Comparative Example 1; however, the glass beading defect was decreased in Inventive Examples 1 to 3 including a copper oxide powder.

As set forth above, according to exemplary embodiments of the present disclosure, the residual carbon may be removed at low temperature before the necking between the metal particles is generated and the metal particles are densified during a firing process of the external electrodes, thereby decreasing the blister and glass beading defects.

While exemplary embodiments have been shown and described above, it will be apparent to those skilled in the art that modifications and variations could be made without departing from the spirit and scope of the present disclosure as defined by the appended claims.

What is claimed is:

1. A conductive paste composition for an external electrode, comprising:
a copper powder; and
a copper oxide powder.

2. The conductive paste composition for an external electrode of claim 1, wherein the copper oxide powder includes at least one selected from a group consisting of CuO and Cu₂O.

3. The conductive paste composition for an external electrode of claim 1, wherein the copper oxide powder includes a surface copper oxide powder having an oxide layer formed on a surface thereof.

4. The conductive paste composition for an external electrode of claim 1, wherein the copper oxide powder is included in an amount of 5 parts by weight to 42 parts by weight based on 100 parts by weight of the copper powder.

5. The conductive paste composition for an external electrode of claim 1, wherein the copper oxide powder has an oxide content of 15000 ppm or more.

6. The conductive paste composition for an external electrode of claim 1, wherein the copper oxide powder has an average particle size of 0.3 μm to 10 μm.

7. The conductive paste composition for an external electrode of claim 1, wherein a removing rate of residual carbon is 99.5% or more during a firing process of the conductive paste composition for an external electrode at 600° C.

8. A multilayer ceramic electronic component comprising:
a ceramic body including a plurality of dielectric layers;
first and second internal electrodes formed in the ceramic body with the dielectric layers interposed therebetween to be alternately exposed to end surfaces of the ceramic body; and
first and second external electrodes formed on outer surfaces of the ceramic body to be electrically connected to the first and second internal electrodes, respectively,
wherein the first and second external electrodes include copper and copper oxide.

9. The multilayer ceramic electronic component of claim 8, wherein the copper oxide is at least one selected from a group consisting of CuO, Cu₂O, and a surface copper oxide having an oxide layer formed on a surface thereof.

10. The multilayer ceramic electronic component of claim 8, wherein the copper oxide is included in an amount of 5 parts by weight to 42 parts by weight based on 100 parts by weight of the copper.

11. The multilayer ceramic electronic component of claim 8, wherein the first external electrode and the second external electrode have an oxygen content of 5000 to 15000 ppm.

12. A manufacturing method of a multilayer ceramic electronic component, the manufacturing method comprising:
preparing a plurality of ceramic sheets;
forming internal electrode patterns on the ceramic sheets;
stacking the ceramic sheets having the internal electrode patterns formed thereon to form a ceramic body;
forming an external electrode pattern on at least one surface of the ceramic body using a conductive paste composition for an external electrode including a copper powder and a copper oxide powder; and
firing the external electrode pattern to form an external electrode.

13. The manufacturing method of claim 12, wherein the copper oxide powder is at least one selected from a group consisting of CuO, Cu₂O, and a surface copper oxide having an oxide layer formed on a surface thereof.

14. The manufacturing method of claim 12, wherein the copper oxide powder is included in an amount of 5 parts by weight to 42 parts by weight based on 100 parts by weight of the copper powder.

15. The manufacturing method of claim 12, wherein the copper oxide powder has an oxygen content of 15000 ppm or more.

16. The manufacturing method of claim 12, wherein a removing rate of residual carbon is 99.5% or more during the firing of the external electrode pattern at 600° C.
